(19) United States
(12) Patent Application Publication
(10) Pub. No.: US 2011/0162128 A1
(43) Pub. Date: Jul. 7, 2011

(54) COMPOSITE COATED FABRIC TO RESIST PUNCTURE

(76) Inventor: Lawrence Jacob Welton, Manchester Center, VT (US)

(21) Appl. No.: 12/652,258

(22) Filed: Jan. 5, 2010

(51) Int. Cl. A41D 19/00; B32B 5/02; B32B 5/16

(52) U.S. Cl. 2/163; 428/221; 442/73; 2/167

(57) ABSTRACT

A composite coated fabric to resist puncture includes: a waterproof resin; a textile backing; and a grit bonded to the backing with the resin. The grit helps resist puncture to the material. The material may be made with multiple layers, and may be used to make gloves or other apparel.

### BACKGROUND OF THE INVENTION

The present invention generally relates to fabric, and more specifically, to a composite coated fabric to resist puncture.

There is danger of puncture injury to the skin of an individual by sharp pointed objects such as a pin, needle, hypodermic needle, knife point, or similar object. This is particularly true of the hands when the object(s) are held or utilized.

Existing systems are not effective against hypodermic needles, are extremely costly, are difficult to produce, are not capable of producing test results that are consistent in performance metrics, are bulky and inflexible, and some current methods wear out or tear quickly in the field.

Existing methods include using either a costly high density polymer based fiber textile impregnated with specific rubber-like resins or various fabrics coated with patterned applications of specific hardened resin designs, or using or applying a thick, dense, or hard material, such as a patch, plate, or insert, to a garment or similar carrying medium so that said material can be worn as a shield. These methods are very costly, very inflexible, heavy, uncomfortable, or a combination of several of these undesirable features.

As can be seen, there is a need for a fabric to resist puncture for items such as gloves.

### SUMMARY OF THE INVENTION

In one aspect of the present invention, a material includes: a waterproof resin; a textile backing; and a grit bonded to the backing with the resin; wherein the grit helps resist puncture to the material.

In another aspect of the present invention, a method of resisting puncture includes: covering with a material that includes a waterproof resin, a textile backing, and a grit bonded to the backing; wherein the grit helps resist puncture to the material.

These and other features, aspects and advantages of the present invention will become better understood with reference to the following drawings, description and claims.

### BRIEF DESCRIPTION OF THE DRAWINGS

FIG. 1 depicts an embodiment of a material according to the present invention;

FIG. 2 depicts an alternative embodiment of a multi-layer material according to the present invention; and

FIG. 3 depicts an exemplary embodiment of a glove according to the present invention using the material of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally provides a composite coated fabric providing resistance to puncture by pointed objects such as pins and needles.

An embodiment of the present invention may be incorporated into gloves or garments at areas of vulnerability to reduce the possibility of puncture and therefore injury to the wearer of the garment or glove so modified. An embodiment may address the various means by which a glove, garment or article of apparel can offer puncture, cut, or abrasion resistance with a minimum loss of flexibility, dexterity, or sensitivity. These means may include thickness, density, and hardness.

An embodiment uses hard and abrasive particles bonded to a suitable textile by means of a waterproof resin or glue. Embodiments may be produce at low cost, and be effective in resisting puncture by hypodermic needles. Embodiments may be flexible, test to high standards, and be applied to a wide selection of textiles and used in a broad range of finished products. Embodiments may be incorporated into products that will wear well and last long in the field.

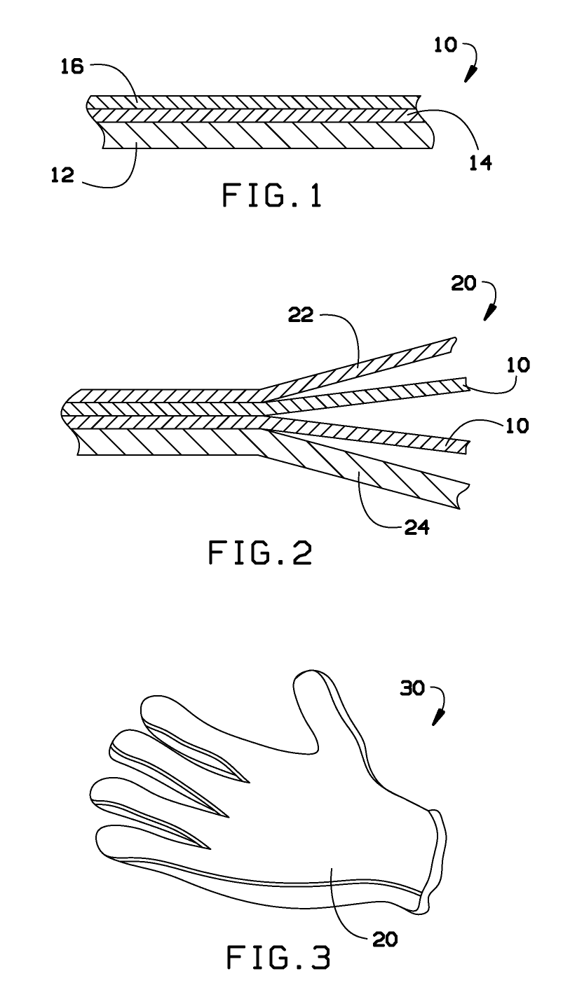

As depicted in FIG. 1, an embodiment of the present invention is a puncture-resistant material 10 that includes a cloth backing 12, a waterproof resin 14, and grit 16. The material 10 may be made by bonding a hardened abrasive grit 16 such as aluminum oxide or silicon carbide to a suitable woven fabric 12 by means of a glue or resin 14 that is both flexible and insoluble in water when hardened.

As depicted in FIG. 2, an embodiment of the present invention is a multi-layer material 20 that includes two layers of puncture-resistant material 10, with an outer layer 22 that includes leather, synthetic leather, or fabric, and an inner layer 24 that includes an inner face material for comfort against the skin, insulation, or high performance, which may be aramid or similar for maximum cut protection.

As depicted in FIG. 3, an embodiment of the present invention 30 is glove that is includes the multi-layer material 20. Other embodiments include apparel other than gloves to protect a person from puncture, or embodiments that otherwise utilize the puncture-resistant material 10.

In an embodiment, the finished textile is cut into pattern parts for assembly into a glove or garment. One or more identical cut pattern parts of the textile may be used to form multiple layers of protection. The cut parts are combined onto an outer garment or glove material such as leather, imitation leather, woven fabric, or knit fabric. The outer fabric may or may not be previously cut into final pattern form when the performance textile part(s) are attached.

In an alternate embodiment, an additional fabric may be attached to the innermost side of the performance textile pattern parts (the side facing the wearer) as an inner face or lining, particularly if the final product will be in direct contact with the skin of the wearer.

In an embodiment, the joining of pattern parts from the performance textile, outer material, and optional inner material may be accomplished by stitching, bonding, thermal weld, or other suitable method. The combined pattern parts may be joined together by stitching, bonding, thermal weld, or other suitable method to form a completed glove, garment, or article of apparel.

In an embodiment, when the completed item is worn, the outer material provides the outward appearance of the finished item, protects the patient from the abrasive nature of the performance textile portions of the item, and protects the integrity and characteristics of the performance textile. An embodiment of the performance textile gives the completed glove, garment, or article of apparel the attributes of puncture resistance, cut resistance, and abrasion resistance for the purpose of protecting the hand or body from injury.

An embodiment of the invention may add an additional layer or layers of material to conventional gloves and garments to increase thickness with a minimal impact on flexibility, dexterity, and sensitivity. The performance textile may also have a high density relative to its weight or thickness. This may impact flexibility, dexterity, and sensitivity to a degree, but not excessively. Hardness is provided by the abrasive grit to cut, abrasion, and puncture protection. A thin layer of flexible particles may be harder than steel, and resist compromise by sharp points and sharp edges. In addition, the grit may degrade the sharpness of any point or edge upon contact, further degrading the invading implement's ability to achieve penetration.

To make an embodiment, equipment or methods used in the fabrication of emery cloth may be used to manufacture the performance textile. Pattern parts may be cut singly or in layers using hydraulic press or electric knife. Cut pattern parts can by assembled using sewing machines.

It should be understood, of course, that the foregoing relates to exemplary embodiments of the invention and that modifications may be made without departing from the spirit and scope of the invention as set forth in the following claims.

We claim:

1. A material comprising:
a waterproof resin;
a textile backing; and
a grit bonded to the backing with the resin;
wherein the grit helps resist puncture to the material.

2. The material of claim 1, wherein the textile is a flexible cloth, and the material is a flexible material adapted to be utilized for apparel.

3. The material of claim 1, further comprising:
an outer layer, adapted to form an outer surface of an apparel; and
an inner layer, adapted to form an inner surface of the apparel;
wherein the material, the outer layer, and the inner layer cooperate to form a puncture-resistant material for the apparel.

4. The material of claim 3, wherein the outer layer is selected from the group consisting of leather, synthetic leather, and fabric.

5. The material of claim 3, further comprising:
a second layer of the material, wherein the material, the second layer of material, the outer layer, and the inner layer cooperate to form a puncture-resistant material for the apparel.

6. The material of claim 1, further comprising:
a glove having a surface made of the material.

7. The material of claim 1, further comprising:
a glove having a palm and palm-side fingers that include surfaces made of the material.

8. The material of claim 1, wherein the grit is selected from the group consisting of: aluminum oxide and silicon carbide.

9. A method of resisting puncture, comprising:
covering with a material that includes a waterproof resin, a textile backing, and a grit bonded to the backing;
wherein the grit helps resist puncture to the material.

10. The method of claim 9, further comprising:
covering a hand with a glove that includes the material;
thereby resisting puncture to the hand.
